(19) United States
(12) Patent Application Publication
(10) Pub. No.: US 2026/0039200 A1
(43) Pub. Date: Feb. 5, 2026

(54) BOOST CONVERTER CIRCUITS

(71) Applicant: Nordic Semiconductor ASA, Trondheim (NO)

(72) Inventors: Erkki Juhani NOKKONEN, Oulu (FI); Juha-Matti KUJALA, Oulu (FI); Geir KJOSAVIK, Trondheim (NO)

(73) Assignee: Nordic Semiconductor ASA, Trondheim (NO)

(21) Appl. No.: 19/100,088

(22) PCT Filed: Aug. 10, 2023
(86) PCT No.: PCT/EP2023/072173

§ 371 Date: Jan. 30, 2025

(30) Foreign Application Priority Data
Aug. 11, 2022 (GB) 2211764.2

(51) Int. Cl. H02M 3/158; H02J 7/00

(52) U.S. Cl. CPC H02M 3/158; H02J 7/0047; H02J 7/00712; H02J 2207/20

(57) ABSTRACT

A boost converter circuit is disclosed comprising an input to receive an input voltage from a battery; an output to generate a higher, output voltage for powering a further circuit portion; and a switching arrangement to control generation of the output voltage. The boost converter circuit compares the input voltage with a first reference input voltage and controls the switching arrangement to limit the output current of the boost converter circuit based on the comparison. The boost converter circuit monitors a parameter indicative of a condition of the battery, determines a second, lower reference input voltage in response to the monitored parameter, compares the input voltage with the second reference input voltage and controls the switching arrangement to limit the output current of the boost converter circuit based on the comparison of the input voltage and the second reference input voltage.

### BACKGROUND OF THE INVENTION

The present invention relates to boost converter circuits and related circuits.

Electronic devices are often powered using direct current (DC) power sources such as batteries. In many cases the unloaded (also referred to as nominal) voltage of the power source does not match one or more voltage requirements of the electronic device, and can also vary according to the age of the power source, its state of charge and/or ambient conditions (e.g. temperature). For instance, a particular single cell battery might generate an unloaded voltage of between 1.5 V and 1.7 V when it is fully charged, and between 0.9 V and 1.1 V when nearly fully discharged. Many electronic devices often require higher voltages to operate, such as 3 V or 5 V.

Some devices utilise a boost converter (also known as a step-up converter) to step up an input voltage (e.g. from a low-voltage battery) to a higher output voltage suitable for operating the device, whilst correspondingly stepping down an input current to a lower output current. Conservation of energy dictates that the input and output voltage and current of a boost converter are related according to:

$${I}_{o u t} = K ( \frac{{V}_{in}}{{V}_{o u t}} ) {I}_{i n} , \qquad ( 1 )$$

where Iᵢₙ, Iₒᵤₜ, Vᵢₙ and Vₒᵤₜ are the input and output currents and voltages, and K is the efficiency of the boost converter.

The current demands of a device can vary over time (e.g. as the device performs different functions or enters into different power modes). Boost converters must therefore be capable of delivering different amounts of output current at different times.

Typically, a boost converter is controlled to maintain a target output voltage. For instance, if the current demand of a device supplied by a boost converter increases, the output voltage will momentarily drop, which can be detected and compensated for (i.e. by the boost converter drawing a greater input current from the input power source). However, this approach may not be optimal for power sources which have relatively low current capabilities (e.g. low-capacity batteries), as simply drawing more current from these may cause the input voltage to decrease (e.g. due to a voltage drop over non-zero internal resistances), which actually causes the output current to decrease (see equation (1) above). Moreover, losses to internal resistances are undesirable for devices that seek to minimise energy use (e.g. battery-powered devices that seek to maximise battery life).

An improved approach to boost converter control may be desired.

### SUMMARY OF THE INVENTION

According to a first aspect of the present invention there is provided a boost converter circuit comprising:
an input arranged to receive an input voltage from a battery;
an output arranged to generate a higher, output voltage for powering a further circuit portion; and
a switching arrangement arranged to control generation of the output voltage;
wherein the boost converter circuit is arranged:
   to compare the input voltage with a first reference input voltage;
   to control the switching arrangement to limit the output current of the boost converter circuit based on the comparison of the input voltage and the first reference input voltage;
   to monitor a parameter indicative of a condition of the battery; to determine a second, lower reference input voltage in response to the monitored parameter;
   to compare the input voltage with the second reference input voltage; and
   to control the switching arrangement to limit the output current of the boost converter circuit based on the comparison of the input voltage and the second reference input voltage.

Thus, it will be seen by those skilled in the art that the operation of a boost converter circuit may be made more reliable and optimal by controlling its switching arrangement in response to an input voltage. Moreover, the boost converter circuit may be able to use energy stored in the battery more optimally, because the way in which the switching arrangement is controlled takes into account the battery's condition (via the second reference input voltage).

As explained above, the input and output voltages and currents of a boost converter circuit are related according to equation (1). The voltage Vᵢₙ and current Iᵢₙ supplied by a power source, its unloaded operating voltage Vᵤₙₗ and its internal resistance Rᵢₙₜ are related according to:

$${V}_{i n} = {V}_{u n l} - {I}_{i n} {R}_{i n t} , \qquad ( 2 )$$

$$∴ {I}_{i n} = \frac{{V}_{u n l} - {V}_{i n}}{{R}_{i n t}} . \qquad ( 3 )$$

Combining equations (1) and (3) means that the output current of the boost converter, Iₒᵤₜ, can be expressed as:

$$\begin{matrix}{I}_{o u t} = K ( \frac{{V}_{i n}}{{V}_{o u t}} ) ( \frac{{V}_{u n l} - {V}_{i n}}{{R}_{i n t}} ) & \\ = ( \frac{K}{{V}_{o u t} {R}_{int}} ) ( {V}_{u n l} {V}_{i n} - {V}_{i n}^{2} ) & ( 5 )\end{matrix} . \qquad ( 4 )$$

It can be seen therefore that for a constant output voltage Vₒᵤₜ, unloaded voltage Vᵤₙₗ and internal resistance Rᵢₙₜ, the output current Iₒᵤₜ is a non-linear function of the input voltage Vᵢₙ. Therefore, controlling the boost converter circuit according to the input voltage may allow for more optimal control over the output current than conventional approaches. For instance, without mitigation the input voltage of a battery (e.g. a low capacity battery) may drop significantly from an unloaded value depending on the current drawn and internal resistances (e.g. as Iᵢₙ increases in equation (2), Vᵢₙ decreases). Controlling the boost converter circuit based on the input voltage may allow this effect to be monitored and accounted for. This may, for instance, allow the boost converter circuit to be controlled to produce an output current that is optimised for long battery life.

Moreover, as batteries age and/or discharge, their internal properties (e.g. internal resistance and/or unloaded voltage) change. The condition of a battery may represent an assessment of one or more of these internal properties. The condition of a battery may generally deteriorate as the battery ages and discharges. Determining the second reference input voltage in response to a parameter indicative of the condition of the battery allows these changes to be accounted for when controlling operation of the switching arrangement. In other words, this may allow the operation of the boost converter circuit to be optimised even as the condition of the battery changes. For instance, the switching arrangement may, in response to the comparison of the input voltage with the second reference input voltage, operate in such a way to maintain a desired output voltage and current even as the battery condition changes. This may allow more energy to be usefully extracted from a battery over its lifetime and/or over a charge cycle than previous approaches which do not take into account parameters indicative of battery condition.

The boost converter circuit may be arranged to control the switching arrangement to limit the output current of the boost converter circuit if the input voltage is equal to (or approximately equal to) or is less than the first and/or second reference input voltage. In other words, the switching arrangement may operate to maintain the input voltage at or above the first and/or second reference input voltage. The switching arrangement may be arranged to pause operation of the boost converter circuit if the input voltage is equal to or less than the first and/or second reference input voltages.

The boost converter circuit may comprise an input comparator arranged to compare the input voltage with the first and/or second reference input voltage. For instance, the input comparator may be arranged to receive the input voltage and the first and/or second reference input voltage as inputs.

The boost converter may comprise separate input comparators for each reference input voltage. However, in a set of embodiments a single input comparator is used for comparing the input voltage with the first reference input voltage and the second reference input voltage. For instance, the boost converter circuit may be arranged to change an input to the input comparator from the first reference input voltage to the second reference input voltage. The boost converter circuit may comprise a multiplexer arranged to output the first or the second reference input voltage in response to the monitored parameter (e.g. in response to the output voltage). The output of the multiplexer may be connected to an input of the input comparator.

The second reference input voltage may be determined in response to a deterioration in battery condition indicated by the monitored parameter. This may allow for more useful energy to be extracted from the battery as its condition deteriorates. For instance, equation (4) can be rearranged to give:

$${V}_{o u t} = K ( \frac{{V}_{i n}}{{I}_{o u t}} ) \frac{{V}_{u n l} - {V}_{i n}}{{R}_{i n t}} . \qquad ( 6 )$$

As the condition of the battery deteriorates (e.g. as the battery ages and/or discharges), its internal resistance Rᵢₙₜ increases. If the input voltage is held at or above a constant reference level during this deterioration, equation (6) shows that the increase in internal resistance will necessitate a corresponding decrease in output current and/or a decrease in output voltage. Neither may be desirable for maintaining proper operation of the further circuit portion. However, by using a second, lower reference input voltage when the monitored parameter indicates a deterioration in the condition of the battery, a desired output current and output voltage may be maintained. In other words, permitting a reduction in the input voltage as the internal resistance Rᵢₙₜ increases allows Iₒᵤₜ and Vₒᵤₜ to be maintained for longer.

The parameter indicative of a condition of the battery may comprise a state of health (SOH) metric or state of charge (SOC) metric. The parameter may comprise an internal resistance or an unloaded voltage of the battery.

However, in a set of embodiments the parameter indicative of a condition of the battery is the output voltage. The boost converter circuit may be arranged to measure the output voltage. As shown in equation (5) above, the output voltage can be indicative of the battery's condition because, without mitigation, the output voltage will decrease as the internal resistance increases. Monitoring the output voltage may be relatively easy to implement. Moreover, controlling the boost converter circuit in response to the output voltage rather than another parameter indicative of the battery's condition may be particularly advantageous because it is often important to regulate the output voltage (e.g. to maintain it above a minimum operational voltage of the further circuit portion). Controlling the boost converter circuit in response to the output voltage may allow for undesired changes in the output voltage to be corrected more quickly than control based on another indicator of the battery condition.

Monitoring the parameter may comprise comparing the parameter to a threshold. For instance, the boost converter circuit may be arranged to compare the input voltage with the first reference input voltage or the second reference input voltage in response to the monitored parameter crossing a threshold. For instance, the boost converter circuit may be arranged to compare the input voltage with the first reference input voltage when the monitored parameter is above a threshold and to compare the input voltage with the second reference input voltage when the monitored parameter is below the threshold (e.g. when the parameter indicates that the battery condition has deteriorated to a certain level). The threshold may be selected based on known characteristics of the battery and/or of the further circuit portion. In a set of embodiments, the threshold is a threshold output voltage equal to or just above (e.g. 1%, 5%, 10% or 20% above, or 0.1 V, 0.2 V or 0.5 V above) a minimum operational voltage for the further circuit.

Additionally or alternatively, monitoring the parameter may comprise measuring the parameter. The second reference input voltage may be determined using the measured parameter, e.g. the second reference input voltage may be a function of the measured parameter.

The boost converter circuit may be arranged to generate an alert in response to the monitored parameter. For instance, the boost converter circuit may be arranged to generate an alert if the parameter (e.g. the output voltage) crosses a threshold value which triggers the determination of the second reference input voltage. The alert may comprise an indication of the condition of the battery. For instance, the alert may comprise a low battery warning or a suggestion to replace and/or recharge the battery. The boost converter circuit may be configured to send said alert to the further circuit portion (e.g. to trigger a low battery mode or a sleep mode).

Controlling the boost converter circuit based on the input voltage may, for instance, allow the current output by the boost converter to be maximised. This may be desirable for applications requiring large currents from small batteries. For example, the first or second reference input voltage may be selected such that the switching arrangement limits the output current of the boost converter circuit when the input voltage indicates that the output current is near or at a maximum value. In other words, the boost converter circuit may be prevented from attempting to deliver a higher current when the input voltage has dropped to a value indicating that the output current is at its maximum possible level.

The maximum of equation (5) is found when

$${V}_{in , max} = \frac{{V}_{u n l}}{2} .$$

In other words, the theoretical maximum output current of the boost converter occurs when the input voltage drops to half of its unloaded value. Accordingly, the first and/or second reference input voltage may be equal to half or approximately half of an unloaded battery voltage (e.g. between 35% and 65% of an unloaded battery voltage or between 45% and 55% of an unloaded battery voltage). Preferably the first and/or second reference input voltage is no lower than half of the unloaded battery voltage.

However, in many battery powered devices it may be desirable to maximise the energy usefully extracted from the battery, e.g. to maximise battery life. In such applications, controlling a boost converter to extract the maximum current from the battery may not be optimal, because this may lead to inefficiencies such as large resistive losses over an internal resistance of the battery. Therefore, in a set of embodiments the first and/or second reference input voltage may be selected such that the output current of the boost converter circuit is limited to a level below a maximum possible output current of the boost converter circuit. For instance, the first and/or second reference input voltage may be equal to more than half of an unloaded battery voltage (e.g. more than 51% of an unloaded battery voltage, more than 60% of an unloaded battery voltage or more than 70% of an unloaded battery voltage). It will be recognised from equation (5) that setting the first and/or second reference input voltage to be equal to more than half of an unloaded battery voltage and controlling the switching arrangement to limit the output current such that the input voltage does not drop below said reference input voltage(s) means that the output current is artificially limited to a level below the maximum possible output current. This may allow more energy to be extracted from the battery as less energy is lost to resistive losses over the internal resistance of the battery.

In some embodiments, the boost converter circuit comprises one or more input capacitors connected in parallel to the input. In some embodiments, the boost converter circuit comprises one or more output capacitors connected in parallel to the output. Input and output capacitor(s) may act as charge reservoirs for moments of high current demand. For instance, providing one or more output capacitors may allow a current demanded by the further circuit portion to be met for a short period time even if the maximum permitted output current of the boost converter circuit is less than that an instantaneous current demanded by the further circuit portion. This may facilitate the extraction of more useful energy from the battery, because a lower current (with lower associated resistive losses) may be drawn from the battery over a longer time period, with the capacitor(s) making up any current shortfall in moments of high demand and then being recharged with the lower current afterwards.

As explained above, switching from the first reference input voltage to the second reference input voltage may allow for more energy to be extracted from the battery as it ages and discharges. In some embodiments it may be useful to switch to a third reference input voltage as the battery condition declines further. Accordingly, in a set of embodiments the boost converter circuit is arranged to determine a third reference input voltage in response to the monitored parameter, to compare the input voltage with the third reference input voltage; and to control the switching arrangement to limit the output current of the boost converter circuit in response to the comparison of the input voltage with the third reference input voltage.

The third reference input voltage may be lower than the second reference input voltage, i.e. to allow further energy to be extracted from the battery. In some embodiments further lower reference input voltages may be used in a similar manner.

It will be understood that the unloaded battery voltage refers to the terminal voltage output by the battery when it is not subject to any load. The unloaded battery voltage can also vary over time depending for instance on the age of the battery, its state of charge and/or ambient conditions such as temperature. Thus, whilst the unloaded battery voltage may (in at least some circumstances) be a useful metric for selecting the first and/or second reference input voltages in order to tune the current output, in practice this unloaded battery voltage may not be known to the boost converter circuit. For instance, a boost converter circuit may be designed to operate with several different batteries with different unloaded battery voltages, and the unloaded battery voltages can themselves vary according to local ambient conditions, their state of charge, their age and/or other operational parameters.

In some embodiments the boost converter circuit may be arranged to estimate and/or directly measure an unloaded battery voltage. In such embodiments the unloaded battery voltage may comprise the parameter indicative of a condition of the battery. However, the additional circuitry required for this may be prohibitive. Thus, in some embodiments, additionally or alternatively, the first and/or second reference input voltage (and/or further reference input voltages) has a predetermined value. The predetermined value(s) may be selected based on expected characteristics of the battery. Whilst the use of fixed reference input voltages may not always be strictly optimal, the applicant has recognised that it can provide good performance for a wide range of battery voltages whilst being simpler to implement than actively measuring an unloaded battery voltage.

The invention extends to a circuit system comprising:
a battery arranged to generate an input voltage; and the boost converter circuit as disclosed herein, wherein the input is connected to the input voltage generated by the battery.

The present invention may be particularly relevant for low capacity batteries, i.e., batteries for which it may be important to minimise energy losses. The battery may comprise a low capacity battery, e.g. a battery having a nominal capacity of less than 2000 mWh, less than 1000 mWh, less than 500 mWh or less than 250 mWh. The battery may comprise a button cell or coin battery such as a CR2032 battery.

The circuit system may comprise a further circuit portion (e.g. a System-on-Chip) connected to the output. The further circuit portion may have a minimum operational voltage. The second reference input voltage may be determined in response to the monitored parameter to maintain the output voltage above the minimum operational voltage.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a schematic diagram of a circuit system according to an embodiment of the invention;

FIGS. 2 and 3 are a timing diagrams illustrating the operation of the circuit portion in FIG. 1;

FIG. 4 is a schematic diagram of a circuit system according to another embodiment of the invention; and

FIG. 5 is a timing diagrams illustrating the operation of the circuit portion in FIG. 4.

### DETAILED DESCRIPTION

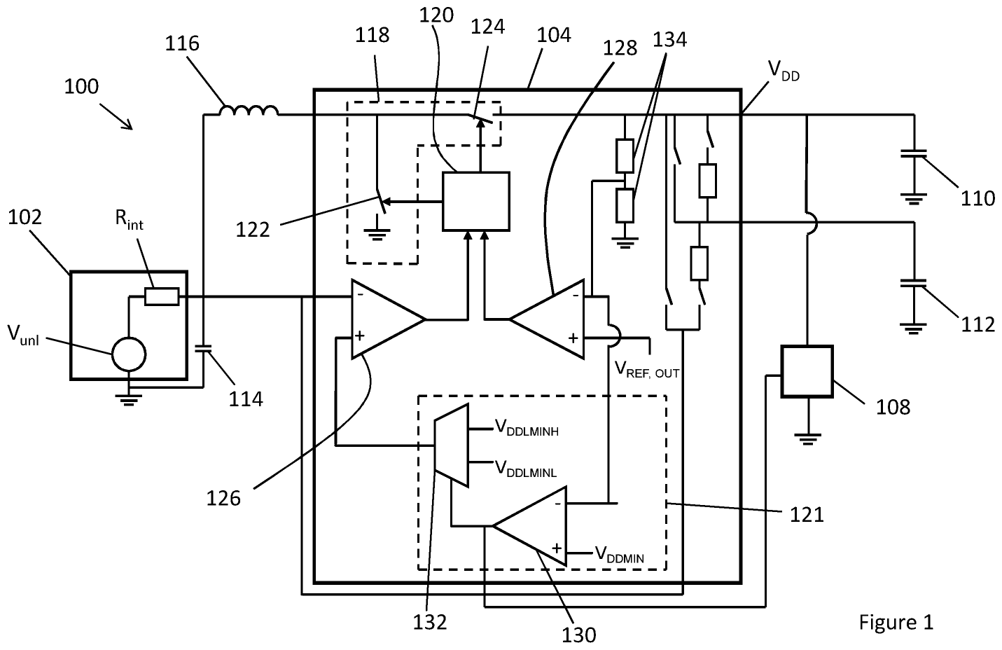

FIG. 1 shows a circuit system 100 comprising a battery 102, a boost converter circuit 104 and a System-on-Chip (SoC) 108. The battery 102 and the boost converter 104 together power the SoC 108. As will be explained in more detail below, the boost converter circuit 104 receives an input voltage V_{DDL} from the battery 102 and provides a higher output voltage V_{DD} to the SoC 108. The SoC 108 requires a minimum operational voltage V_{DDRESET} of 1.7 V.

The SoC 108 requires a voltage of between 1.8 and 3.6 V to operate. Allowing for a small margin of error, the SoC 108 specifies a minimum voltage V_{DDMIN} of 2 V. The battery 102 has a non-zero internal resistance Rᵢₙₜ and an unloaded voltage Vᵤₙₗ. Rᵢₙₜ and Vᵤₙₗ vary depending on the state of charge of the battery 102 and the age of the battery 102. The unloaded voltage Vᵤₙₗ is typically between 1.1 V and 1.7 V. The internal resistance Rᵢₙₜ is typically around 20 Ω.

The SoC 108 is connected to the output voltage V_{DD} in parallel with a first decoupling capacitor 110 and a second decoupling capacitor 112. The second decoupling capacitor 112 has a larger capacitance than the first decoupling capacitor 110. During normal operation, the decoupling capacitors 110, 112 “decouple” the SoC 108 from any noise in the power supplied by the boost converter circuit 104, and also provide a charge reservoir for satisfying transient higher current demands from the SoC 108. Similarly, the boost converter circuit 104 itself is connected to the battery 102 in parallel with a battery decoupling capacitor 114. The battery decoupling capacitor 114 also acts to smooth noise and as a charge reservoir for the boost converter circuit 104.

The boost converter circuit 104 comprises an inductor 116 connected to the input voltage V_{DDL}, a switching arrangement 118, a boost control circuit portion 120 and an input voltage control portion 121.

The boost control circuit portion 120 controls operation of the switching arrangement 118. The switching arrangement 118 comprises a first switch 122 operable to connect the inductor 116 to ground and a second switch 124 operable to connect the inductor 116 to the output of the boost converter 104.

The boost control circuit portion 120 receives inputs from a first comparator 126 and a second comparator 128. The first comparator 126 compares the input voltage V-_{DDL} with a reference input voltage provided by the input voltage control portion 121.

The second comparator 128 compares a divided version of the output voltage V_{DD}/α (with a determined by a pair of voltage divider resistors 134), with a reference output voltage V_{REF, OUT}. The reference output voltage V_{REF, OUT} is selected such that αV_{REF, OUT} equals a target output voltage. In this case, the target voltage is 3 V. The reference output voltage V_{REF, OUT} may be programmable, to correspond with different target voltages, e.g. for powering different SoCs.

The input voltage control portion 121 comprises an output voltage comparator 130 and a multiplexer 132. The output voltage comparator 130 receives the divided version of the output voltage V_{DD}/α at its inverting input, and an output voltage threshold V_{DDMIN} at its non-inverting input. The multiplexer 132 comprises two inputs, a first reference input voltage V_{DDLLMINH} and a second, lower reference input voltage V_{DDLLMINL}. The output of the multiplexer 132 is the reference input voltage supplied to the first comparator 126. When the output of the output voltage comparator 130 is high (i.e. when the divided version of the output voltage V_{DD}/α is higher than the output voltage threshold V_{DDMIN}), the multiplexer 132 outputs the first reference input voltage V_{DDLLMINH}. When the output of the comparator 130 is low (i.e. when the divided version of the output voltage V_{DD}/α is lower than the output voltage threshold V_{DDMIN}) the multiplexer 132 outputs the second reference input voltage V_{DDLMINL}.

In use, the boost converter circuit 104 boosts the first voltage V_{DDL} from the battery 102 to the output voltage V_{DD} by switching the first and second switches 122, 124 on and off repeatedly. Each cycle of boost converter operation involves the following steps:
1. The first switch 122 closes (with the second switch 124 open) and connects the right end of the inductor 116 to ground (0 V). The current through the inductor 116 ramps up with time, as does the magnetic field generated by the inductor 116. The length of time for which the first switch 122 is closed (and the resulting current set up in the inductor 116) is controlled by the boost control circuit portion 120 based on the output current requirement of the boost converter circuit 104.
2. The first switch 122 opens and the second switch 124 closes. Now, the right end of the inductor 116 is connected to the output of the boost converter circuit 104. The magnetic field in the inductor 116 will force the current to continue to flow in the same direction as before, to the output of the boost converter circuit 104. A voltage (e.m.f.) is set up over the inductor 116 in series with the input voltage V_{DDL}, to produce a higher output voltage V_{DD}.
3. When the current through the inductor 116 goes to zero, the second switch 124 opens. Both switches 122, 124 now remain open until the beginning of the next boost cycle. Alternatively, in a different mode of boost, the switches 122, 124 remain open until the output voltage V_{DD} falls below the reference output voltage V_{REF, OUT}.

In other words, in boost converter operation the switches 122, 124 are controlled to repeatedly store energy in the magnetic field of the inductor 116 and then release this to produce the boosted output voltage V_{DD}. As long as sufficient current is supplied from the battery 102, this process maintains the output voltage V_{DD} at the predetermined target voltage at the output of the boost converter circuit 104.

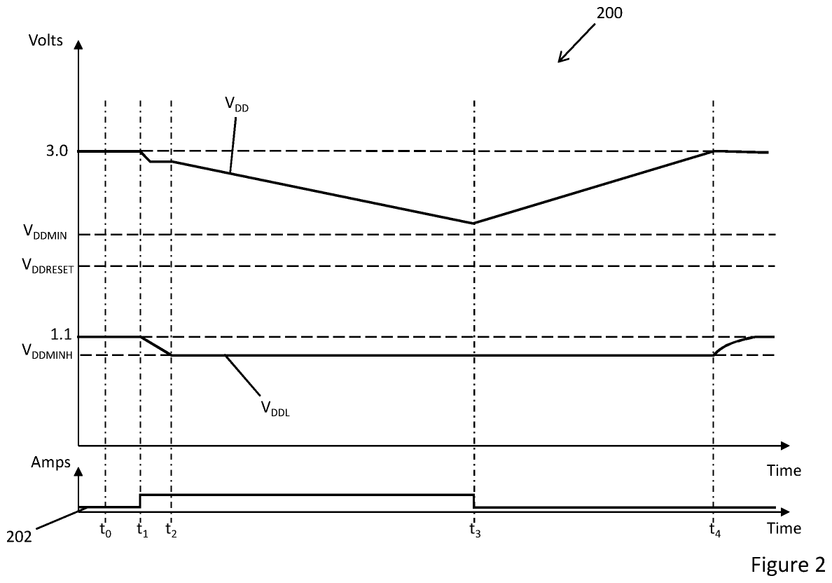

FIG. 2 shows a timing diagram 200 illustrating the operation of the boost converter circuit 104 with a new and fully charged battery 102. At an initial time t₀, the SoC 108 is drawing no or very little load 202. The boost converter circuit 104 delivers a stable output voltage V_{DD} of 3.0 V, with the input voltage V_{DDL} at 1.1 V. The output voltage V_{DD} is above V_{DDMIN}, so the multiplexer 132 provides the first reference input voltage V_{DDLMINH} to the first comparator 126.

However, the current demanded by the SoC 108 varies. For instance, operations such as programming, transmitting and receiving may demand relatively large currents while other operations require very little current. At time t₁. the SoC 108 begins to draw an increased load 202 (e.g. because a transmission cycle begins). At first, the boost converter circuit 104 simply reacts to stop V_{DD} from dropping significantly by providing the necessary increased current, using charge supplied by the battery decoupling capacitor 114. As the charge on the battery decoupling capacitor 114 is used up, the increased current demand on the battery 102 causes V_{DDL} to drop (due to an increased voltage drop over the internal resistance Rᵢₙₜ).

At t_{2,} V_{DDL} drops below the first reference input voltage, V_{DDLMINH}. This causes the first comparator 126 to output a low signal to the control circuit portion 120. In response, the control circuit portion 120 stops boost converter operation and stops delivering current to the output of the boost converter circuit 104.

Whilst the boost converter operation is stopped, the current demand at the output is delivered by the first and second decoupling capacitors 110, 112, and the output voltage V_{DD} slowly falls as the decoupling capacitors 110, 112 are discharged.

After some time, when V_{DDL} has recovered to a voltage slightly higher than the reference input voltage, V_{DDLMINH} (to account for hysteresis of the first comparator 126), the first comparator 126 outputs a high signal to the control circuit portion 120 and boost converter operation starts again. This repeats whilst the current demand remains high, having the effect of stabilising the input voltage V_{DDL} at reference input voltage, V_{DDLMINH} and limiting the current output of the boost converter circuit 104.

The first reference input voltage V_{DDLMINH} is selected so that the output current of the boost converter circuit 104 is limited at a level below the maximum possible output current. The maximum output current may be delivered when the input voltage V_{DDL} is equal to half of the unloaded battery voltage (see equation (5) above), so V_{DDLMINH} is selected to be greater than half of the unloaded battery voltage. In this example the unloaded battery voltage is 1.1 V and V_{DDLMINH} is 1 V. Allowing the boost converter circuit 104 to draw less than the maximum possible current increases the amount of energy that can be extracted from the battery 102 because less energy is lost to the internal resistance of the battery 102. The size of the capacitors 110, 112 may be chosen to ensure that sufficient current can still be delivered to the SoC 108 during periods of load high load. In other words, the boost converter circuit 104 may act to average the current drawn from the battery 102 to reduce energy losses associated with large current spikes.

After the current limiting kicks in at t₂, the current demanded by the SoC 108 is higher than the maximum output current of the boost converter circuit 104. Thus, the output voltage V_{DD} begins to drop as charge is used up from the decoupling capacitors 110, 112. This drop continues until t₃. when the load 202 drawn by the SoC 108 drops back to its initial low value. However, the decoupling capacitors 110, 112 (and the battery decoupling capacitor 114) still need to be recharged. The decoupling capacitors 110, 112 thus continue to draw a large output current from the boost converter circuit 104 (which continues to limit the output current by switching on and off based on the level of V_{DDL}) until they are fully recharged at time t₄. The current demanded from the boost converter circuit 104 then returns to a low level and the battery decoupling capacitor 114 re-charges to 1.1 V. The system 100 is now ready for the next load pulse e.g. the next transmission cycle.

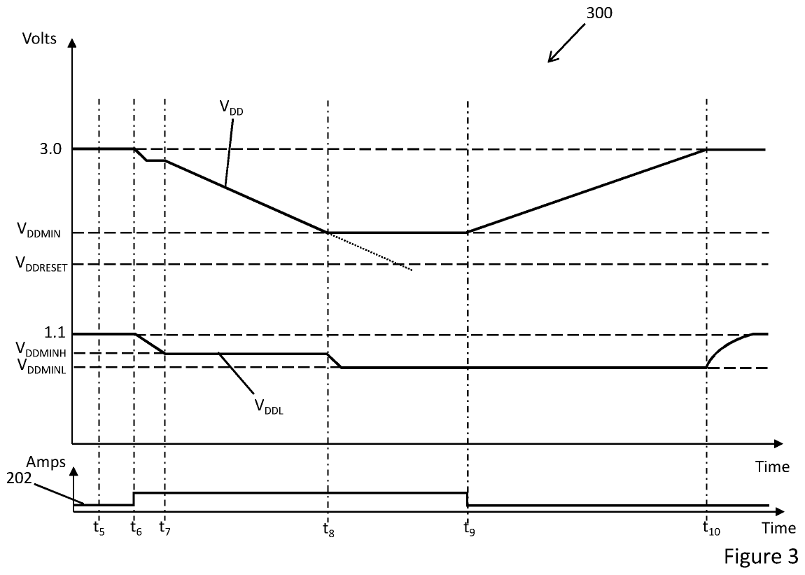

FIG. 3 shows a timing diagram 300 illustrating the operation of the boost converter circuit 104 at a later time, when the battery 102 has partially discharged. As a result of the discharging, the internal resistance Rᵢₙₜ has increased, i.e., the condition of the battery 102 has deteriorated.

At time t₅, the SoC 108 is drawing no or very little load 202. Despite the fact that the battery's condition has deteriorated, the load 202 is small and the boost converter circuit 104 is still able to deliver a stable output voltage V_{DD} of 3.0 V, with the input voltage V_{DDL} at 1.1 V. The output voltage V_{DD} is above V_{DDMIN}, so the multiplexer 132 provides the first reference input voltage V_{DDLMINH} to the first comparator 126.

At time t₆. the load 202 drawn by the SoC 108 increases (e.g. because a transmission cycle begins). As before, the boost converter circuit 104 initially reacts to stop V_{DD} from dropping significantly by providing the necessary increased current using charge supplied by the battery decoupling capacitor 114. As the charge on the battery decoupling capacitor 114 is used up, the increased current demand on the battery 102 causes V_{DDL} to drop (due to an increased voltage drop over the internal resistance Rᵢₙₜ).

At t_{7,} V_{DDL} drops below the first reference input voltage, V_{DDLMINH}. This causes the first comparator 126 to output a low signal to the control circuit portion 120. In response, the control circuit portion 120 stops boost converter operation and stops delivering current to the output of the boost converter circuit 104. As before, the boost converter circuit 104 is switched on and off to limited the output current and stabilise the input voltage V_{DDL} around the first reference input voltage, V_{DDLMINH}. However, because the internal resistance Rᵢₙₜ has increased, the battery 102 provides a smaller input current than before and the boost converter circuit 104 must limit the output current at a corresponding lower level to maintain V_{DDL} at V_{DDLMINH}. This causes the output voltage V_{DD} to drop more quickly. The output voltage V_{DD} is thus indicative of the condition of the battery 102.

As indicated by the dotted line in FIG. 3, if the output voltage V_{DD} continued to drop at this rate it would reach the minimum operational voltage V_{DDRESET} for the SoC 108 before the end of the load pulse and the SoC 108 would stop working. Therefore the boost converter circuit 104 monitors the output voltage using the output voltage comparator 130 and takes appropriate mitigating action. At time t₈, the output voltage V_{DD} reaches the output voltage threshold V_{DDMIN}. This causes the output of the output voltage comparator 130 to go low and the multiplexer 132 to output the second, lower reference input voltage V_{DDLMINL}. When the output voltage V_{DD} reaches the output voltage threshold V_{DDMIN} the boost converter circuit 104 the low output of the output voltage comparator 132 is sent to the SoC 108 as an alert identifying the decline in battery condition indicated by the drop in the output voltage V_{DD} (e.g. a “low battery” alert that indicates that the battery may need replacing or recharging soon).

The second reference input voltage V_{DDLMINL} is also selected so that the output current of the boost converter circuit 104 is limited at a level below the maximum possible output current.

Because the multiplexer 132 is now outputting the second, lower reference input voltage V_{DDLMINL.}, at time t₈ the boost converter circuit 104 allows the input voltage V_{DDL} to drop to V_{DDLMINL}. This compensates for the increase in Rᵢₙₜ and allows the boost converter circuit 104 to maintain the output voltage V_{DD} at or slightly above the threshold V_{DDMIN} (see equation (6)). In other words, by relaxing the input voltage requirement the boost converter circuit 104 allows additional energy to be extracted from the battery 102. This allows the boost converter circuit 104 to maintain the output voltage V_{DD} above V_{DDRESET} throughout the whole load pulse.

When the load pulse ends at time t_{9,} the decoupling capacitors 110, 112 are recharged to 3.0 V and at time t₁₀ the battery decoupling capacitor 114 re-charges to 1.1 V. The output of the voltage comparator 130 goes high and the multiplexer 132 once again outputs the first reference input voltage V_{DDLMINH}.

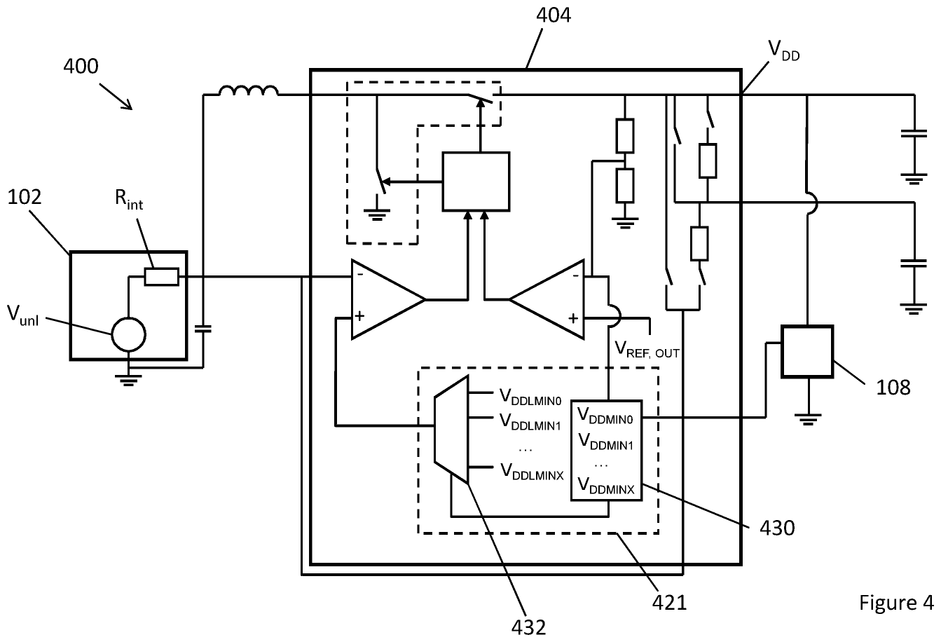

FIG. 4 illustrates another circuit portion 400 comprising a battery 102, a boost converter circuit 404 and a System-on-Chip (SoC) 108. The battery 102 and the boost converter 404 together power the SoC 108. The battery 102 and the SoC 108 are identical to those described above. The boost converter circuit 404 is the same as the boost converter circuit described above aside from the input voltage control portion 421. As explained above, the boost converter circuit 404 receives an input voltage V_{DDL} from the battery 102 and provides a higher output voltage V_{DD} to the SoC 108.

The normal operation of the boost converter circuit 404 is the same as that described above with reference to FIGS. 1 and 2. However, in this embodiment the input voltage control portion 421 comprises a comparison portion 430 and a multiplexer 432 with a plurality of inputs which receive a plurality of reference input voltages V_{DDLMIN0}-V_{DDLMINX}. The comparison portion 430 compares the divided version of the output voltage V_{DD}/α to a plurality of reference output voltages V_{DDMIN0}- V_{DDMINX}, and uses the multiplexer 423 to provide an appropriate reference input voltage V_{DDLMIN0}-V_{DDLMINX} to the first comparator 126.

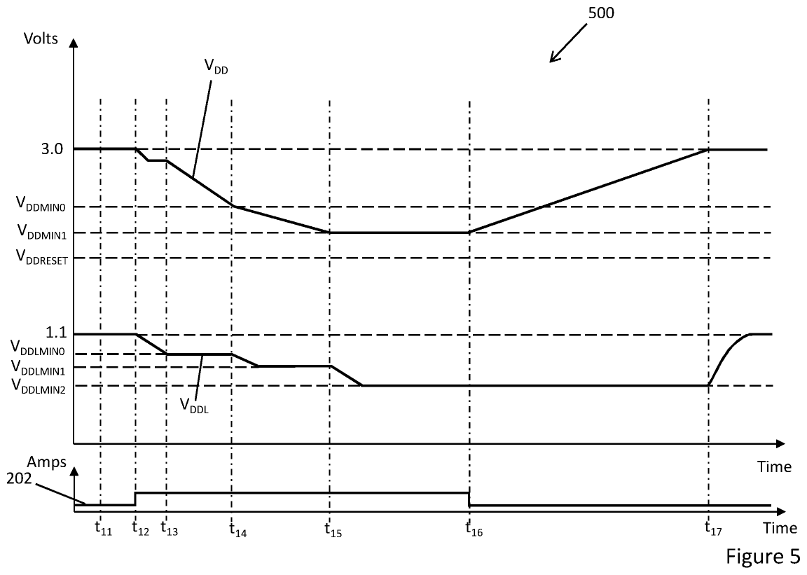

FIG. 5 shows a timing diagram 500 illustrating the operation of the boost converter circuit 404.

At time t₁₁, the SoC 108 is drawing no or very little load 202. The boost converter circuit 404 delivers a stable output voltage V_{DD} of 3.0 V, with the input voltage V_{DDL} at 1.1 V. The output voltage V_{DD} is above V_{DDMIN0}, so the multiplexer 432 provides the first reference input voltage V_{DDLMIN0} to the first comparator 426.

At time t₁₂, the SoC 108 begins to draw an increased load 202 (e.g. because a transmission cycle begins). As before, the boost converter circuit 404 initially reacts to stop V_{DD} from dropping significantly by providing the necessary increased current using charge supplied by the battery decoupling capacitor 114. As the charge on the battery decoupling capacitor 114 is used up, the increased current demand on the battery 102 causes V_{DDL} to drop (due to an increased voltage drop over the internal resistance Rᵢₙₜ).

At t_{13,} V_{DDL} drops below the first reference input voltage, V_{DDLMIN0}. This causes the first comparator 126 to output a low signal to the control circuit portion 120. In response, the control circuit portion 120 stops boost converter operation and stops delivering current to the output of the boost converter circuit 104.

As before, the boost converter circuit 404 is switched on and off to limited the output current and stabilise the input voltage V_{DDL} around the first reference input voltage, V_{DDLMIN0}. The first reference input voltage V_{DDLMIN0} is selected so that the output current of the boost converter circuit 404 is limited at a level below the maximum possible output current. This permitted current is lower than that demanded by the SoC 108. As such the output voltage V_{DD} continues to drop as the charge on capacitors 110, 112 is used up.

At time t₁₄, the output voltage V_{DD} reaches the first reference output voltage V_{DDMIN0}. The comparison portion 430 detects this and controls the multiplexer 423 to provide the second reference input voltage V_{DDLMIN1} to the first comparator 126. The comparison portion 430 also sends an alert to the SoC 108 identifying the decline in battery condition indicated by the drop in the output voltage V_{DD}.

The second reference input voltage V_{DDLMIN1} is also selected so that the output current of the boost converter circuit 104 is limited at a level below the maximum possible output current. This current is greater than that available for the first reference input voltage V_{DDLMIN0} but is still insufficient to meet the current demands of the SoC 108. The output voltage V_{DD} continues to drop.

At time t₁₅, the output voltage V_{DD} reaches the second reference output voltage V_{DDMIN1}. The comparison portion 430 detects this and controls the multiplexer 423 to provide a third reference input voltage V_{DDLMIN2} to the first comparator 126. The comparison portion 430 also sends an alert to the SoC 108 identifying the decline in battery condition indicated by the fact that the output voltage V_{DD} has dropped to the second reference output voltage V_{DDMIN1}.

The third reference input voltage V_{DDLMIN2} may also be selected so that the output current of the boost converter circuit 104 is limited at a level below the maximum possible output current. This current is greater than that available for the first and second reference input voltages V_{DDLMIN0}, V_{DDLMIN1}. This is now sufficient to meet the current demands of the SoC 108. The output voltage V_{DD} stabilises at V_{DDMIN1}. However, later in the battery's life further corresponding reductions in the reference input voltage may be necessary to maintain the output voltage above V_{DDRESET}, i.e., to extract the maximum possible energy from the battery 102.

The load pulse ends at time t₁₆. The decoupling capacitors 110, 112 then recharge to 3.0 V and at time t₁₇ the battery decoupling capacitor 114 re-charges to 1.1 V. The comparison portion 430 detects this and controls the multiplexer 423 to once again provide the first reference input voltage V_{DDLMIN02} to the first comparator 126.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A boost converter circuit comprising:
an input arranged to receive an input voltage from a battery;
an output arranged to generate a higher, output voltage for powering a further circuit portion; and
a switching arrangement arranged to control generation of the output voltage; wherein the boost converter circuit is arranged:
to compare the input voltage with a first reference input voltage;
to control the switching arrangement to limit the output current of the boost converter circuit based on the comparison of the input voltage and the first reference input voltage;
to monitor a parameter indicative of a condition of the battery;
to determine a second, lower reference input voltage in response to the monitored parameter;
to compare the input voltage with the second reference input voltage; and
to control the switching arrangement to limit the output current of the boost converter circuit based on the comparison of the input voltage and the second reference input voltage.

2. The boost converter circuit of claim 1, arranged to control the switching arrangement to limit the output current of the boost converter circuit if the input voltage is equal to or is less than the first and/or second reference input voltage.

3. The boost converter circuit of claim 1, comprising an input comparator arranged to compare the input voltage with the first and/or second reference input voltage.

4. The boost converter circuit of claim 1, arranged to compare the input voltage with the first reference input voltage when the monitored parameter is above a threshold and to compare the input voltage with the second reference input voltage when the monitored parameter is below the threshold.

5. The boost converter circuit of claim 1, wherein the parameter indicative of a condition of the battery is the output voltage.

6. The boost converter circuit of claim 1, arranged to generate an alert in response to the monitored parameter.

7. The boost converter circuit of claim 1, wherein the first and/or second reference input voltage is selected such that the output current of the boost converter circuit is limited to a level below a maximum possible output current of the boost converter circuit.

8. The boost converter circuit of claim 1, wherein the first and/or second reference input voltage is more than half of an unloaded battery voltage of the battery.

9. The boost converter circuit of claim 1, comprising one or more output capacitors connected in parallel to the output.

10. The boost converter circuit of claim 1, arranged to determine a third reference input voltage in response to the monitored parameter, to compare the input voltage with the third reference input voltage; and to control the switching arrangement to limit the output current of the boost converter circuit in response to the comparison of the input voltage with the third reference input voltage.

11. A circuit system comprising:
a battery arranged to generate an input voltage; and
a boost converter circuit comprising:
an input connected to the input voltage generated by the battery;
an output arranged to generate a higher, output voltage for powering a further circuit portion; and
a switching arrangement arranged to control generation of the output voltage; wherein the boost converter circuit is arranged:
to compare the input voltage with a first reference input voltage;
to control the switching arrangement to limit the output current of the boost converter circuit based on the comparison of the input voltage and the first reference input voltage;
to monitor a parameter indicative of a condition of the battery;
to determine a second, lower reference input voltage in response to the monitored parameter;
to compare the input voltage with the second reference input voltage; and
to control the switching arrangement to limit the output current of the boost converter circuit based on the comparison of the input voltage and the second reference input voltage.

12. The circuit system of claim 11, wherein battery has a nominal capacity of less than 2000 mWh.

13. The circuit system of claim 11, comprising the further circuit portion connected to the output.

14. The circuit system of claim 13, wherein the further circuit portion has a minimum operational voltage and the second reference input voltage is determined in response to the monitored parameter to maintain the output voltage above the minimum operational voltage.
